(19) United States
(12) Patent Application Publication
(10) Pub. No.: US 2016/0103766 A1
(43) Pub. Date: Apr. 14, 2016

(54) LOOKUP OF A DATA STRUCTURE CONTAINING A MAPPING BETWEEN A VIRTUAL ADDRESS SPACE AND A PHYSICAL ADDRESS SPACE

(71) Applicant: HEWLETT-PACKARD DEVELOPMENT COMPANY, L.P., Houston, TX (US)

(72) Inventors: Naveen Muralimanohar, Palo Alto, CA (US); Kevin T. Lim, Palo Alto, CA (US); Norman Paul Jouppi, Palo Alto, CA (US); Doe Hyun Yoon, Palo Alto, CA (US)

(73) Assignee: HEWLETT-PACKARD DEVELOPMENT COMPANY, L.P., Houston, TX (US)

(21) Appl. No.: 14/786,268

(22) PCT Filed: Jul. 1, 2013
(86) PCT No.: PCT/US2013/048901

§ 371 Date: Oct. 22, 2015

(51) Int. Cl. G06F 12/10; G06F 12/08

(52) U.S. Cl. CPC G06F 12/1009; G06F 12/0802; G06F 12/1054; G06F 12/1063; G06F 12/0875; G06F 2212/1021; G06F 2212/452; G06F 2212/50; G06F 2212/68

(57) ABSTRACT

A memory region stores a data structure that contains a mapping between a virtual address space and a physical address space of a memory. A portion of the mapping is cached in a cache memory. In response to a miss in the cache memory responsive to a lookup of a virtual address of a request, an indication is sent to the buffer device. In response to the indication, a hardware controller on the buffer device performs a lookup of the data structure in the memory region to find a physical address corresponding to the virtual address.

### BACKGROUND

A computer system can include a secondary storage (also referred to as mass storage) and a memory, where the memory has a faster access speed than the secondary storage. The secondary storage can be implemented with one or multiple disk-based storage devices or other types of storage devices. The memory can be implemented with one or multiple of memory devices. Data stored in the memory can be accessed by a data requester, such as a processor, with lower latency than data stored in the secondary storage.

Due to the widening performance gap between memory and secondary storage, some applications are increasingly relying on use of the memory (instead of the secondary storage) as the primary data store of data.

### BRIEF DESCRIPTION OF THE DRAWINGS

Some embodiments are described with respect to the following figures:

FIG. 1 is a schematic diagram of an example system according to some implementations;

FIG. 2 is a flow diagram of a technique according to some implementations;

FIGS. 3 and 4 are schematic diagrams of different arrangements of buffer devices including a page table, according to some implementations;

FIGS. 5A-5B are schematic diagrams of different arrangements that include memory devices and buffer devices, according to some implementations; and

FIG. 6 is a schematic diagram of an arrangement to hash a virtual address and a process identifier to select one of multiple buffer devices, according to alternative implementations.

### DETAILED DESCRIPTION

A system can use a virtual memory address space to store data in memory. Examples of systems include computer systems (e.g. server computers, desktop computers, notebook computers, tablet computers, etc.), storage systems, or other types of electronic devices. As used here, a memory can be implemented with one or multiple memory devices. Generally, a memory refers to storage that has a lower data access latency than another storage of the system, such as secondary storage implemented with higher latency storage device(s) such as disk-based storage device(s) or other type of storage devices.

A virtual memory address space is not constrained by the actual physical capacity of the memory in the system. As a result, the virtual memory address space can be much larger than the physical address space of the memory. The physical address space includes physical addresses that correspond to physical locations of the memory. In contrast, the virtual address space includes virtual addresses that are mapped to the physical addresses. A virtual address does not point to a physical location of the memory; rather, the virtual address is first translated to a physical address that corresponds to the physical location in memory.

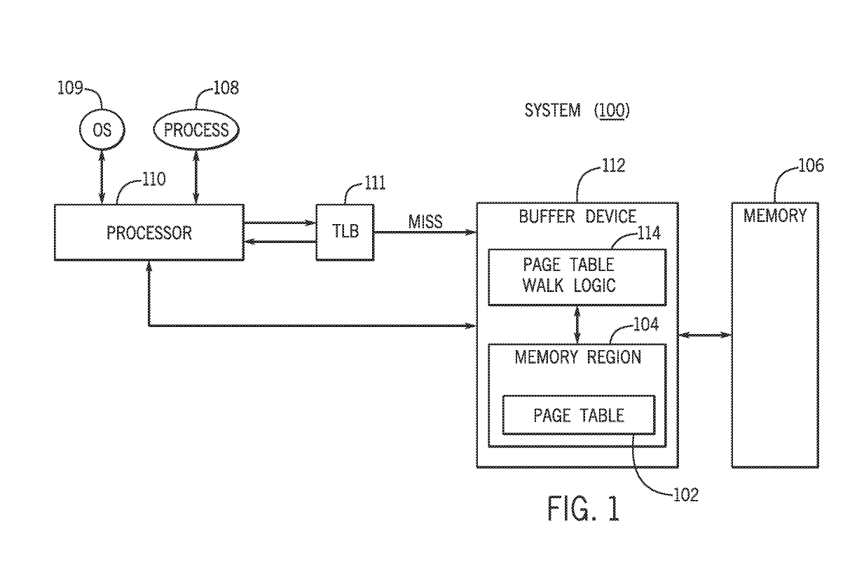

FIG. 1 is a block diagram of an example system 100 that includes a processor 110 and a process 108 executable on the processor 110. The system 100 also includes a memory 106. The process 108 can be a process of an application (e.g. database management application or any other application that can access data). More generally, a process can refer to any entity that is executable as machine-readable instructions in the system 100. Although just one process 108 is depicted in FIG. 1, it is noted that there CaO be multiple processes executing on the processor 110. Also, in further examples, the system 100 can include multiple processors 110.

At the time of memory allocation (allocation of portions of the memory 106 to respective processes executing in the system), an operating system (OS) 109 of the system 100 can create mappings between the virtual address space and the respective physical address space for each process.

In some examples, the OS 109 can store each mapping in a data structure referred to as a page table 102. The page table 102 maps a virtual page (which is a data block of a specified size) used by a process to a respective physical memory page (a block of the memory). The OS 109 can maintain a separate page table for each active process that uses the memory 106.

The processor 108 in the system 100 can execute an instruction (e.g. load instruction or store instruction) of the process 108 that results in an access (read access or write access, respectively) of the memory 106. The address of the instruction is a virtual address that points to a location in the virtual address space. The respective page table 102 can be used to translate the virtual address of the instruction to a physical address. To speed up the address translation process, a subset of the page table 102 can be cached in a cache, referred to as a translation lookaside buffer (TLB) 111. The TLB 111 can store the most recently accessed entries of the page table 102, for example.

When a load or store instruction is issued, the processor 109 first accesses the TLB 111 to find the respective physical address. However, if the TLB 111 does not contain an entry for the virtual address of the instruction, then a miss of the TLB 111 has occurred, in which case a page table walk procedure can be invoked to traverse the page table 102 to find the corresponding physical address. The page table walk procedure traverses through the page table 102 to identify an entry that contains a mapping to map the virtual address of the load or store instruction to a physical address.

In accordance with some implementations, to improve performance of the page table walk procedure as compared to traditional techniques or mechanisms, the page table 102 is stored in a memory region 104 that has a lower access latency than that of the memory 106. In implementations according to FIG. 1, the memory region 104 is associated with a buffer device 112 that is located between the processor 110 and the memory 106.

Storing the page table 102 in the memory region 104 with reduced access latency improves performance of the page table walk procedure over an arrangement in which a page table is stored in the slower memory 106.

In some examples, a page table can be a multi-level page table. A multi-level page table includes multiple page table portions (at different levels) that are accessed in sequence during the page table walk procedure to find an entry that contains a mapping between the virtual address of the load or store instruction and the corresponding physical address. In response to a miss in the TLB 111, the page table walk procedure uses a portion of the virtual address to index to an entry of the page table portion at a highest level of the different levels. The selected entry contains an index to a page table portion at the next lower level. The foregoing iterative process continues until the page table portion at the lowest level is reached. The selected entry of the lowest level page table portion contains an address portion that is combined with some portion (e.g. lowest M bits) of the virtual address to generate the final physical address. Walking through the multiple levels of page table portions is a relatively slow process, especially in implementations where the multi-level page table is stored in the memory 106.

By implementing the page table 102 in the faster memory region 104, the penalty associated with a miss of the TLB 111 can be reduced, since a page table walk procedure in the memory region 104 would be faster than a page table walk procedure in the slower memory 106.

The page table 102 maintained in the faster memory region 104 can be a multi-level page table. In other examples, the page table 102 can be a single-level page table.

The buffer device 112 can be implemented as an integrated circuit (IC) chip. For example, the buffer device 112 can be a die that is part of a memory stack, which is a stack of multiple dies. The stack of dies includes one or multiple memory dies that include respective memory device(s) for storing data. Another of the dies in the memory stack is a logic die, which can include the buffer device 112 (this logic die can be referred to as a buffer device die).

In different examples, the buffer device 112 can be provided on a memory module, on a main circuit board, and so forth. Although just one buffer device 112 is depicted in FIG. 1, multiple buffer devices 112 can be included in other examples, where each of the multiple buffer devices 112 can include respective page tables.

The buffer device 112 can include buffer storage (not shown) for temporarily buffering data that is communicated between the processor 110 and the memory 106. In addition, the buffer device 112 can include logic (not shown) for routing requests and addresses between the processor 110 and the memory 106.

In addition, as depicted in FIG. 1, the buffer device 112 can include a page table walk logic 114 to perform a page table walk procedure of the page table 102 in the memory region 104. The page table walk logic 114 can be implemented as a hardware controller, such as an application specific integrated circuit (ASIC) device, a field programmable gate array (FPGA), or other type of controller.

Although the memory region 104 is shown as being part of the buffer device 112, it is noted that in alternative implementations, the memory region 104 can be implemented separately from the buffer device 112. In such alternative implementations, the memory region 104 can be coupled to the buffer device 112, For example, if the buffer device 112 is in a buffer device die of a memory stack, the memory region 104 can be part of another die that is stacked on top of the buffer device die. Alternatively, the memory region 104 can be part of circuitry directly connected to the buffer device 112 over a point-to-point link. A point-to-point link refers to a link in which two devices connected to the link can communicate directly with each other, without having to seek arbitration for access of the link.

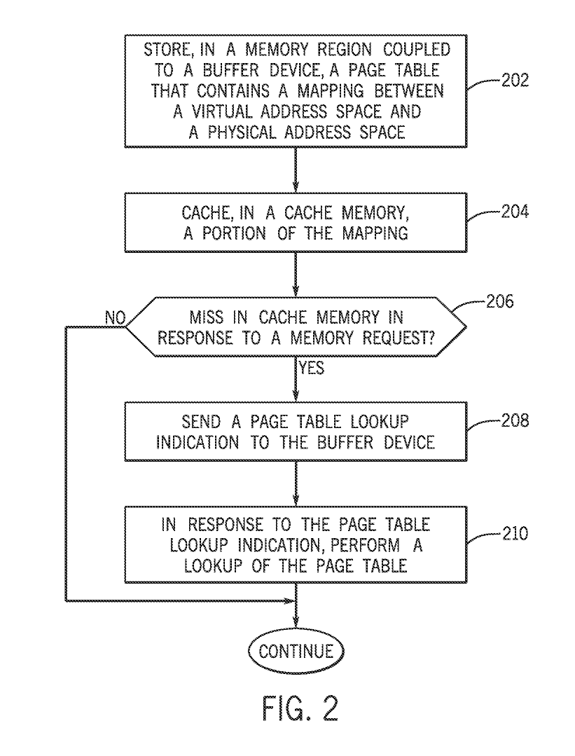

FIG. 2 is a flow diagram of a technique according to some implementations. The process stores (at 202) in the memory region 104 that is coupled to the buffer device 112, a data structure (e.g. page table 102) that contains a mapping between a virtual address space and a physical address space of the memory 106. The process also caches (at 204), in a cache memory such as the TLB 111, a portion of the mapping of the page table 102.

In response to a memory request (e.g. load instruction, store instruction, etc.) of the process 108 that specifies a virtual address, the processor 110 first attempts to determine if the TLB 111 contains an entry corresponding to the virtual address of the memory request. If such entry is not in the TLB 111, then a miss is considered to have occurred.

In response to a miss (as determined at 206) in the TLB 111 responsive to a lookup of a virtual address of the memory request, the processor 110 can send (at 208) a page table lookup indication to the buffer device 112. The page table lookup indication is an indication that a page table walk procedure is to be performed with respect to the page table 102. In response to the page table lookup indication, the page table walk logic 114 performs (at 210) a lookup of the page table 102 in the memory region 104 to find a physical address corresponding to the virtual address of the memory request.

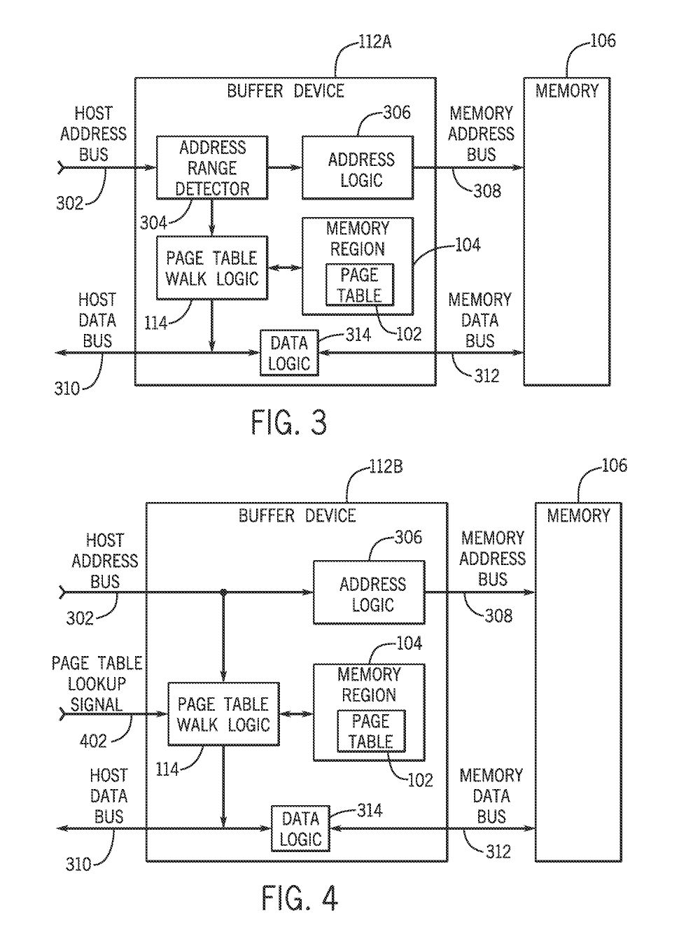

FIG. 3 is a block diagram of an example arrangement that includes a buffer device 112A according to further implementations. In implementations according to FIG. 3, the page table lookup indication that is sent (at 208 in FIG. 2) to the buffer device 112A is a special address that is within a specified address range, which can specify a range of addresses, or alternatively, a single address. The address is provided on a host address bus 302 that is between the processor 110 and the buffer device 112A. The address on the host address bus 302 is received by an address range detector 304 in the buffer device 112A. The address range detector 304 determines whether the received address is within the specified address range. If so, that is an indication that a page table walk procedure is to be performed of the page table 102.

However, if the received address is not in the specified address range, then that is an address for a normal access of the memory 106, in which case the address range detector 304 provides the received address to address logic 306 of the buffer device 112A. The address logic 306 outputs a corresponding address onto a memory address bus 308 that is between the buffer device 112A and the memory 106.

The buffer device 112A is also connected to a host data bus 310 that is between the processor 110 and the buffer device 112A. The host data bus 310 is used to carry data between the processor 110 and the buffer device 112A. In addition, a memory data bus 312 is between the memory 106 and the buffer device 112A.

The buffer device 112A includes data logic 314 that is able to provide data read from the memory 106 to the processor 110 over the host data bus 310, or alternatively, to provide write data from the host data bus 310 to the memory data bus 312 for writing to the memory 106.

In accordance with some implementations, the page table walk logic 114 is also coupled to the host data bus 310. In response to a page table walk procedure, a physical address that is retrieved by the page table walk logic 114 from the page table 102 that corresponds to a virtual address can be output over the host data bus 310 back to the processor 110. The processor 110 can use this physical address to submit a request to access (read access or write access) the memory 106.

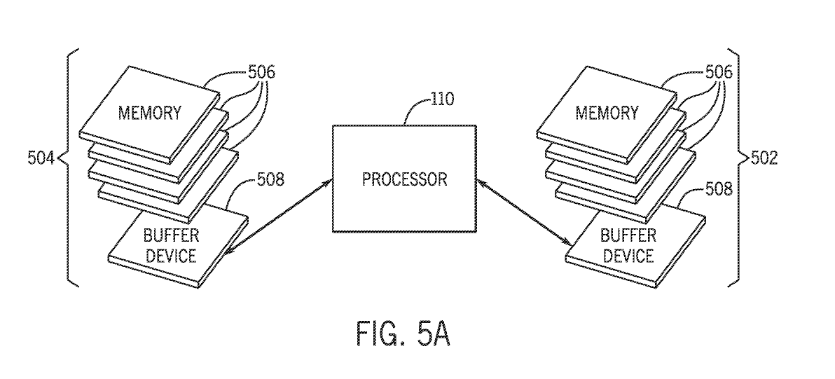

FIG. 4 is a block diagram of an alternative arrangement that includes a buffer device 112B. In the buffer device 112B, the address range detector 304 of FIG. 3 is omitted. However, in accordance with some implementations, a page table lookup control signal 402 is provided to the page table walk logic 114. The page table lookup signal 402 is an express indication to the page table walk logic 114 that a page table walk procedure of the page table 102 is to be performed, in response to an address received over the host address bus 302 (which in this case is a virtual address). A physical address from the page table 102 as a result of the page table walk procedure is then provided back to the processor 110 over the host data bus 310.

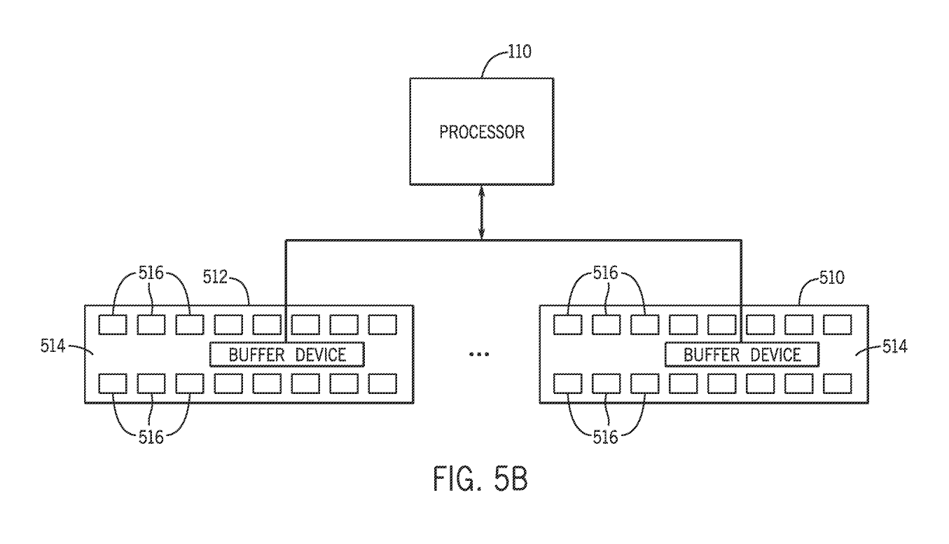

FIGS. 5A and 5B illustrate different examples showing locations of buffer devices. In FIG. 5A, two memory stacks 502 and 504 are depicted. Each memory stack 502 or 504 includes a stack of dies, including memory dies 506 and a buffer device die 508. The buffer device die 508 can include a buffer device arranged according to any of FIGS. 1, 3, and 4.

FIG. 5B shows an example in which buffer devices are provided on memory modules 510 and 512. The memory module 510 or 512 can be a dual inline memory module (DIMM) or other type of memory module. The memory module 510 or 512 is formed of a circuit board 514, on which is arranged various memory devices 516. In addition, a respective buffer device is provided on the circuit board 514. The buffer device can be arranged according to any of the buffer devices depicted in FIGS. 1, 3, and 4.

In other examples, instead of providing the buffer devices on the memory modules 510 and 512 as those shown in FIG. 5B, the buffer devices can be provided on a main circuit board or in another location.

In a system that has multiple buffer devices, each having its respective page table, a single process (e.g. 108 in FIG. 1) can have its page tables span across multiple buffer devices. The OS 109 can use a register (e.g. CR3 register), associated with the single process, that contains an address of the page table. However, since page tables of the process can span multiple buffer devices, using a single register may not allow for proper access of page tables that spans multiple buffer devices.

In some implementations, a process identifier (PID) of a process, such as process 108 in FIG. 1, can be used for performing lookups of page tables in multiple buffer devices. In some examples, a parallel lookup in all of the buffer devices can be performed for a given PID and the virtual address that is to be looked up. In other words, in response to a memory request from a process having PID, where the memory request specifies a given virtual address, the PID and given virtual address are used to perform parallel lookups of the page tables (associated with the PID) in the multiple buffer devices. Performing such parallel lookup may increase buffer complexity and may increase energy consumption, but comes at the benefit of simplifying the design of the OS 109.

In alternative implementations, a hash can be performed on the virtual address and the PID to identify a single buffer device from the multiple buffer devices. A page table lookup can then be performed in the page table of the identified buffer device,

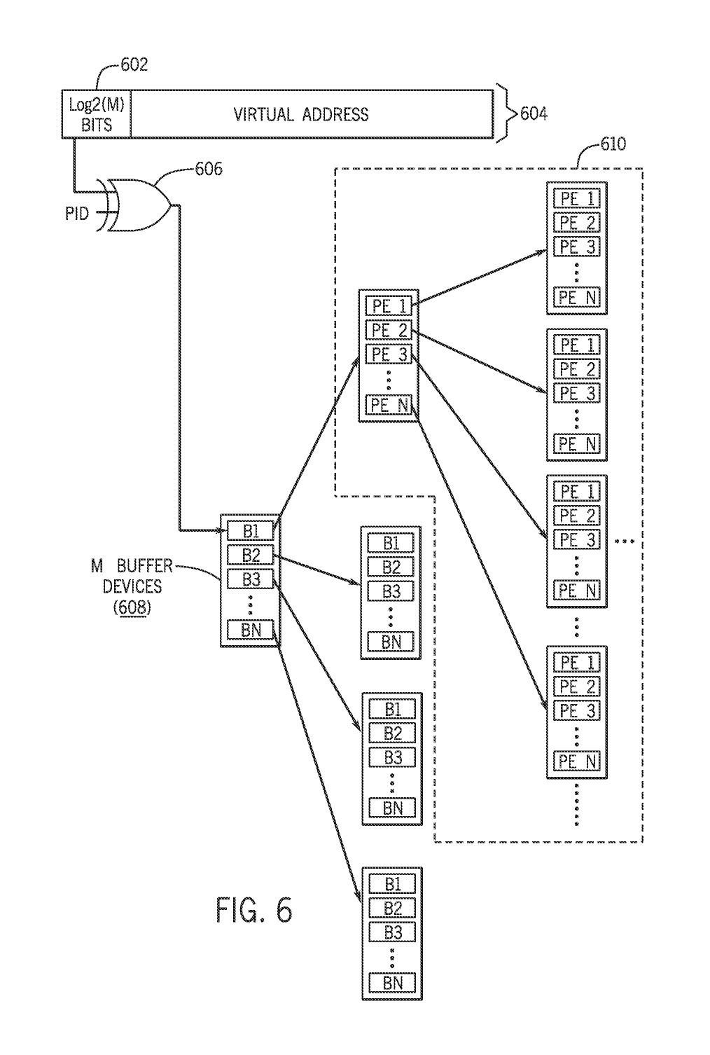

FIG. 6 shows an example of how a hash can be performed to select one of multiple buffer devices in which a page table walk procedure is to be performed. A portion 602 of a virtual address 604 can be input into a hash logic, which can be in the form of an exclusive-OR (XOR) gate 606. The other input of the XOR gate 606 is the PID of the process that generated a memory request specifying the virtual address 604. The XOR gate 606 applies an XOR function on the virtual address portion 602 and the PID. The output of the XOR gate 606 selects one of multiple buffer devices 608.

In alternative implementations, instead of using the XOR gate 606 as the hash logic, other types of hash logic can be provided to apply hashing of the virtual address 604 and the PID.

In FIG. 6, it is assumed that there are M buffer devices 608, where M>1. To select from among the M buffer devices 608, the virtual address portion 602 that is hashed with the PID has a length log₂(M).

Once a buffer device is selected based on the output of the XOR gate 606 606, a page table walk procedure can he performed in the page table of the selected buffer device. In the example of FIG. 6, it is assumed that the page table is a multi-level page table, such that the page table walk procedure traverses the multiple levels of the page table, as indicated by dashed profile 610.

In accordance with some implementations, a constraint can be specified that constrains a page table walk procedure to a single buffer device. Although one process can be associated with page tables in the multiple buffer devices 608, once a buffer device is selected based on the hash applied by the XOR gate 606, then a pointer from a page table portion in the selected buffer device should not lead to an entry of a page table in another buffer device. This constraint can speed up the page table walk procedure since the lookup would not have to traverse multiple buffer devices.

As noted above, the page table walk logic 114 can be implemented using a hardware controller. In some examples, the hardware controller can execute machine-readable instructions, such as firmware or software.

Data and instructions can be stored in respective storage devices, which are implemented as one or more computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
storing, in a memory region coupled to a buffer device, a data structure that contains a mapping between a virtual address space and a physical address space of a memory, wherein the memory region storing the data structure has a lower access latency than the memory, and wherein the buffer device is between the memory and a data requester;
caching, in a cache memory, a portion of the mapping;
in response to a miss in the cache memory responsive to a lookup of a virtual address of a memory request,
sending an indication to the buffer device;
in response to the indication, performing, by a hardware controller on the buffer device, a lookup of the data structure in the memory region to find a physical address corresponding to the virtual address.

2. The method of claim 1, wherein the data structure is a multi-level data structure having portions at a plurality of levels, and wherein the lookup includes traversing the portions at different ones of the plurality of levels to generate the physical address corresponding to the virtual address.

3. The method of claim 2, wherein the data structure is a page table to map a virtual page of a process to a physical page of the memory.

4. The method of claim 1, wherein the buffer device is part of a system that includes a plurality of buffer devices, and wherein each of the plurality of buffer devices includes a respective data structure that contains a mapping between a virtual address space and a physical address space.

5. The method of claim 4, further comprising:
in response to a request of a process specifying the virtual address, performing a lookup of the data structures in the plurality of buffer devices to find the physical address.

6. The method of claim 5, wherein the data structures are associated with a process identifier of the process.

7. The method of claim 4, further comprising:
in response to a request of a process specifying the virtual address, selecting one of the plurality of buffer devices using a process identifier of the process; and
performing a lookup of the data structure in the selected buffer device.

8. The method of claim 7, further comprising:
hashing the process identifier with at least a portion of the virtual address to produce an output value for selecting one of the plurality of buffer devices.

9. A system comprising:
a processor;
a memory;
a buffer device between the processor and the memory;
a memory region coupled to the buffer device and storing a page table that maps between a virtual address space and a physical address space, wherein the memory region storing the page table has a lower access latency than the memory,
wherein the buffer device includes a page table walk logic responsive to an indication to perform a lookup of the page table, wherein the indication is responsive to a miss in a translation lookaside buffer that stores a portion of the page table when looking up a physical address for a virtual address of a request from the processor, and wherein the lookup of the page table in the memory region generates the physical address.

10. The system of claim 9, wherein the indication is an address within a specified address range.

11. The system of claim 9, wherein the indication is a signal indicating that a page table lookup is to be performed.

12. The system of claim 9, wherein the page table walk logic is to provide the physical address retrieved from the page table over a host data bus to the processor.

13. The system of claim 9, further comprising a memory stack including a memory die of the memory and a buffer device die including the buffer device.

14. The system of claim 13, wherein the memory region is part of the buffer device die or on a die stacked on the buffer device die.

15. A buffer device for provision between a data requester and a memory, the buffer device comprising:
a memory region to store a data structure that contains a mapping between a virtual address space and a physical address space of the memory, wherein the memory region storing the data structure has a lower access latency than the memory; and
a hardware controller to:
receive an indication that is responsive to a miss in a cache memory storing a portion of the data structure, the miss being responsive to a lookup in the cache memory of a virtual address specified in a request from the data requester;
in response to the indication, perform a lookup of the data structure in the memory region to find a physical address corresponding to the virtual address.
